(19) United States
(12) Patent Application Publication
(10) Pub. No.: US 2010/0284123 A1
(43) Pub. Date: Nov. 11, 2010

(54) SYSTEMS AND METHODS FOR FABRICATING HIGH-DENSITY CAPACITORS

(76) Inventors: MarkondeyaRaj Pulugurtha, Tucker, GA (US); Andreas Fenner, Chandler, AZ (US); Anna Malin, Phoenix, AZ (US); Kanika Sethi, Atlanta, GA (US); Himani Sharma, Atlanta, GA (US); Dasharatham Janagama Goud, Tucker, GA (US); Rao Tummala, Greensboro, GA (US)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(21) Appl. No.: 12/435,971

(22) Filed: May 5, 2009

(51) Int. Cl. H01G 2/00; B05D 5/12

(52) U.S. Cl. 361/271; 427/79

(57) ABSTRACT

The present invention describes systems and methods for fabricating high-density capacitors. An exemplary embodiment of the present invention provides a method for fabricating a high-density capacitor system including the steps of providing a substrate and depositing a nanoelectrode particulate paste layer onto the substrate. The method for fabricating a high-density capacitor system further includes sintering the nanoelectrode particulate paste layer to form a bottom electrode. Additionally, the method for fabricating a high-density capacitor system includes depositing a dielectric material onto the bottom electrode with an atomic layer deposition process. Furthermore, the method for fabricating a high-density capacitor system includes depositing a conductive material on the dielectric material to form a top electrode.

### FIELD OF THE INVENTION

The present invention relates generally to systems and methods for fabricating high-density capacitors and, more particularly, to systems and methods for fabricating silicon compatible form factor high-density capacitors.

### BACKGROUND

Emerging applications in various electronic and biomedical fields require miniaturized capacitors with relatively high densities and high volumetric efficiencies. Implantable biomedical applications, for example, currently demand ultra-high capacitance densities with relatively low leakage currents at relatively high voltages. Conventional approaches to achieve high capacitance densities have sought to enhance one or more of three fundamental parameters: (a) higher permittivity dielectrics, (b) thinner films, and (c) enhancement in surface area. The first parameter is material-chemistry dependent and the second and third parameters are process-dependent. Advancements in conventional high-density capacitors have mainly been achieved in three types of devices: (1) trench capacitors, (2) multilayer ceramic capacitors, and (3) tantalum capacitors. FIG. 1 provides a graph of these three conventional capacitor architectures and the relationship between the area enhancement factor and the planar capacitance densities enabled by these devices. As shown in FIG. 1, certain conventional tantalum capacitors have been able to achieve capacitance densities of up to 40 μF/cm², with an area enhancement factor of up to around 100. Similarly, as shown in FIG. 1, certain conventional silicon trench capacitors have been able to achieve capacitance densities of between 2-40 μF/cm², with an area enhancement factor of up to around 50. Furthermore, certain conventional multilayer ceramic capacitors silicon trench capacitors have been able to achieve capacitance densities of around 50 μF/cm², with an area enhancement factor of up to around 40. While each of these areas of high-density capacitor development exhibit certain benefits advantages over prior designs, they are still largely insufficient to meet the demands of emerging applications.

The first category of conventional capacitors, trench capacitors, attempt to leverage the fundamental parameter of enhancement in surface area to increase capacitance density. As shown in FIG. 2, a silicon trench capacitor can be created by micromachining silicon and creating a three-dimensional surface. These silicon trenches are often etched by either a wet etching or a dry etching process. Once the trench has been etched, a thermal oxidation, nitradation, or oxynitradation process can be implemented to provide the dielectric layer for the insulator. By relying on developments in low-cost deep etching techniques and moderate k dielectric films, conventional trench capacitors have reached densities of as much as 40 μF/cm² with a stack of three trench capacitors.

While suitable for certain implementations, trench capacitors fail to meet the requirements for many applications because they cannot provide the capacitance density required and the volumetric efficiency required. Trench capacitors fail to meet the volumetric efficiency required for many applications because there is an elastic relationship between the depth of the trench and the capacitance density of the trench capacitor. Therefore, higher capacitance requires a deeper trench and an increase in the volume of the device.

The second category of capacitors, multilayer ceramic capacitors or MLCCs, attempt to provide high-density capacitive structures by implementing a stack of metal and dielectrics, comprised of ceramic material. As shown in FIG. 3, these layers can be stacked alternatively to form a multilayered capacitor. Conventional multilayer ceramic capacitors have reduced the thickness of the dielectric layers to permit an increase in the number of layers in the same die size package; thus, increasing the capacitance density of the package. The ability to fabricate thin dielectric layers of ceramic materials is heavily dependent upon the ability to create highly dispersed, fine-grained ceramic powders. Furthermore, the volumetric efficiency of the multilayer ceramic capacitors increases with a reduction in electrode and dielectric thickness. Conventional multilayer ceramic capacitors fabrication processes have successfully achieved dielectric and electrode thickness of around 2 to 3 microns, resulting in 30 to 50 layers for a 100 micron capacitor device, which can provide a capacitance density of around 60 to 90 μF/cm².

While suitable for certain implementations, multilayer ceramic capacitors fail to meet the requirements for many applications because they cannot provide the capacitance density required, the volumetric efficiency required, and they are not often silicon compatible. The fabrication of multilayer ceramic capacitors is a highly complex process due to the multiple layers of the device. Furthermore, MLCC fabrication must be carried out at high temperatures, which are incompatible with silicon-based implementations. Additionally, multilayer ceramic capacitors require oxidation resistant electrodes to preserve the integrity of the device. Furthermore, one of the most significant drawbacks to multilayer ceramic capacitors architectures is that they require lead connections, which limit the volumetric efficiency of the device and can result in reliability issues. Furthermore, MLCC manufacturing cannot be easily implemented as large planar devices.

The third category of conventional capacitors, tantalum capacitors, attempt to optimize the surface area of the tantalum powder used as the electrode for the capacitor to achieve high capacitive densities. As shown in FIG. 4, the bottom electrode of a conventional tantalum capacitor can be comprised of a pellets of grains or flakes of tantalum powder. These pellets, shown in FIG. 4, of tantalum powder typically contain voids which can be leveraged by a conformal dielectric to increase the surface area of the capacitive component. Certain conventional tantalum capacitor implementations have achieved a capacitance density of around 20 μF/cm² for Break Down Voltage (“BDV”) value of 15. In 6 V implementations, conventional tantalum capacitors have achieved an equivalent capacitance density of around 140 μF/cm².

While suitable for certain implementations, tantalum capacitors fail to meet the requirements for many applications because they cannot provide the capacitance density required, the volumetric efficiency required, and they are not silicon compatible. The fabrication of tantalum capacitors requires sintering of the tantalum pellets at temperatures of around 1900° C. , which is incompatible with silicon-based implementations. Additionally, the dielectric is formed through an anodization, creating tantalum oxide, which has disadvantages as a dielectric material. Furthermore, one of the most significant drawbacks to tanatalum capacitor architectures is that the entire bottom electrode shares a common ground and thus cannot provide independent terminals.

Therefore, it would be advantageous to provide an apparatus and method for efficiently and effectively providing high-density capacitors.

Additionally, it would be advantageous to provide an apparatus and method to provide a thin, planar high-density capacitor interposer that can be implemented in a silicon compatible processes.

Additionally, it would be advantageous to provide an apparatus and method to fabricate a high-density capacitor.

### BRIEF SUMMARY

The present invention describes systems and methods for fabricating high-density capacitors. An exemplary embodiment of the present invention provides a method for fabricating a high-density capacitor system including the steps of providing a substrate and depositing a nanoelectrode particulate paste layer onto the substrate. The method for fabricating a high-density capacitor system further includes sintering the nanoelectrode particulate paste layer to form a bottom electrode. Additionally, the method for fabricating a high-density capacitor system includes depositing a dielectric material onto the bottom electrode with an atomic layer deposition process. Furthermore, the method for fabricating a high-density capacitor system includes depositing a conductive material on the dielectric material to form a top electrode.

In addition to methods for fabricating high-density capacitors, the present invention provides a high-density capacitor system including a substrate and a bottom electrode, wherein the bottom electrode is comprised of nanoelectrode particulate paste layer deposited on the substrate and sintered. The high-density capacitor system further including a dielectric material, wherein the dielectric material is deposited onto the bottom electrode with an atomic layer deposition process. Additionally, the high-density capacitor system includes a top electrode, wherein the top electrode is comprised of a conductive material on the dielectric material.

These and other objects, features and advantages of the present invention will become more apparent upon reading the following specification in conjunction with the accompanying drawing figures.

### BRIEF DESCRIPTION OF THE FIGURES

FIG. 1 provides a graph of three conventional capacitor architectures and the relationship between the area enhancement factor and the planar capacitance densities enabled by these devices.

FIG. 2 provides an illustration of a conventional silicon trench capacitor.

FIG. 3 provides an illustration a conventional a multilayered ceramic capacitor.

FIG. 4 provides an illustration of the pellets of grains or flakes of tantalum powder of a conventional tantalum capacitor.

FIG. 5A provides an illustration of a block diagram of the method for fabricating a high-density capacitor system 500 in accordance with an exemplary embodiment of the present invention.

FIG. 5B provides an illustration of a block diagram of the fourth step 520 of an exemplary embodiment of the method for fabricating a high-density capacitor system 500 involving depositing a dielectric material onto the bottom electrode.

FIGS. 6A-6F provide an illustration of high-density capacitor system 600 created by the method for fabricating a high-density capacitor system 500 in accordance with an exemplary embodiment of the present invention.

FIG. 7A provides an illustration of a partially fabricated high-density capacitor system 600 after the step of sintering the nanoelectrode particulate paste layer 615 in an exemplary embodiment of the method for fabricating a high-density capacitor system 500.

FIG. 7B provides a micrograph of a partially fabricated high-density capacitor system 600 after the step of sintering the nanoelectrode particulate paste layer 615 in an exemplary embodiment of the method for fabricating a high-density capacitor system 500.

FIG. 8 provides an illustration of an atomic layer deposition process 520 in an exemplary embodiment of the method for fabricating a high-density capacitor system 500.

FIG. 9 provides an illustration of an atomic layer deposition process 520 in an exemplary embodiment of the method for fabricating a high-density capacitor system 500.

FIG. 10 provides a graphical comparison of the area enhancement factor and aspect ratios associated with exemplary embodiments of the high-density capacitor system 500 and conventional trench capacitors.

FIGS. 11A-11F provide an illustration of a high-density capacitor system 600 created by the method for fabricating a high-density capacitor system 500 in accordance with an exemplary embodiment of the present invention, in which the high-density capacitor system 600 can be made by creating troughs 1105 in the substrate layer 605 through etching.

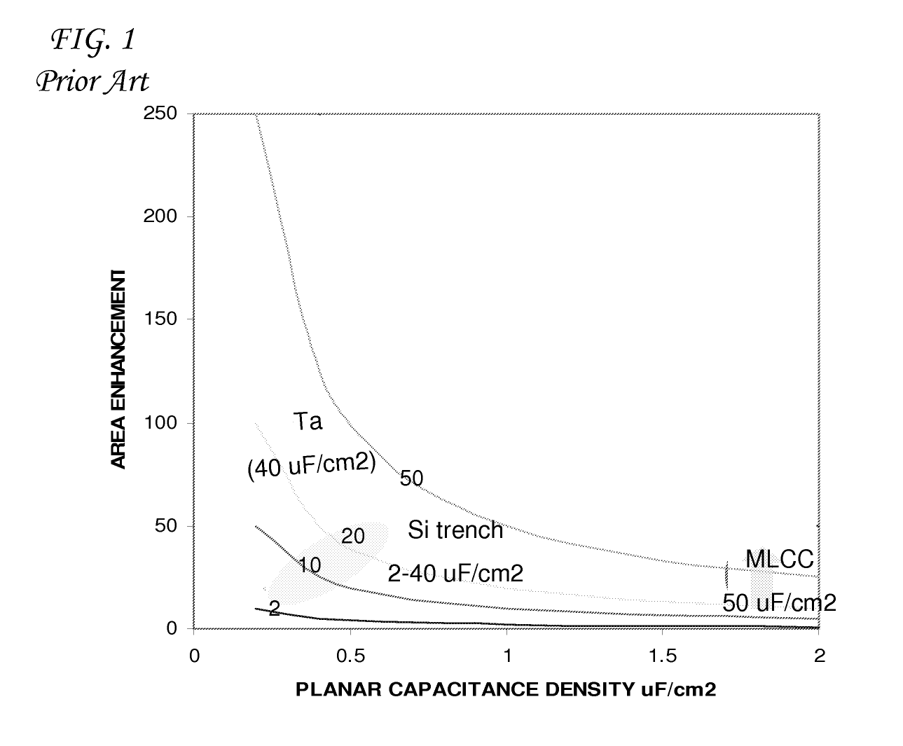

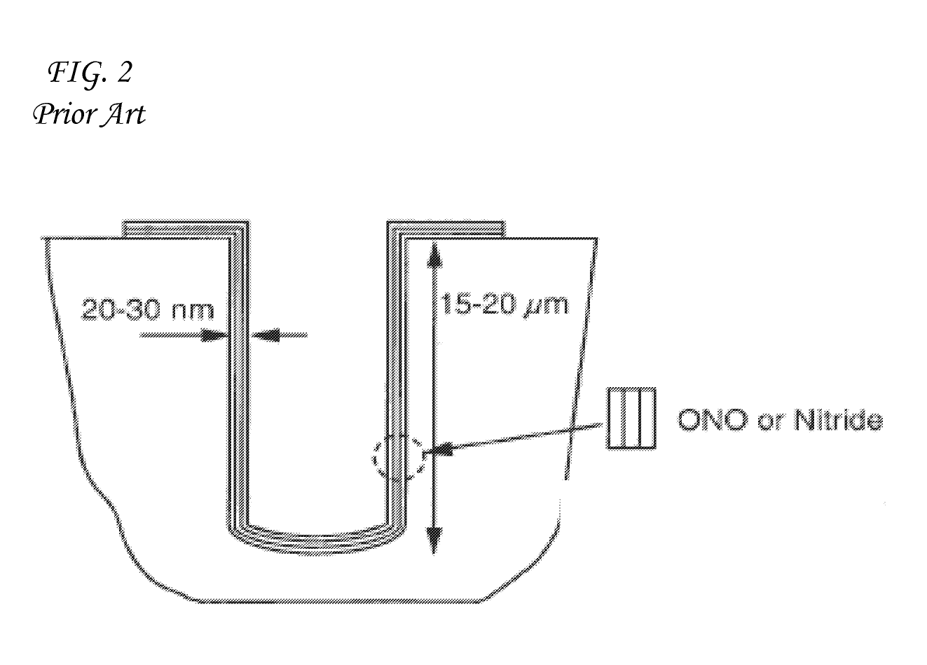

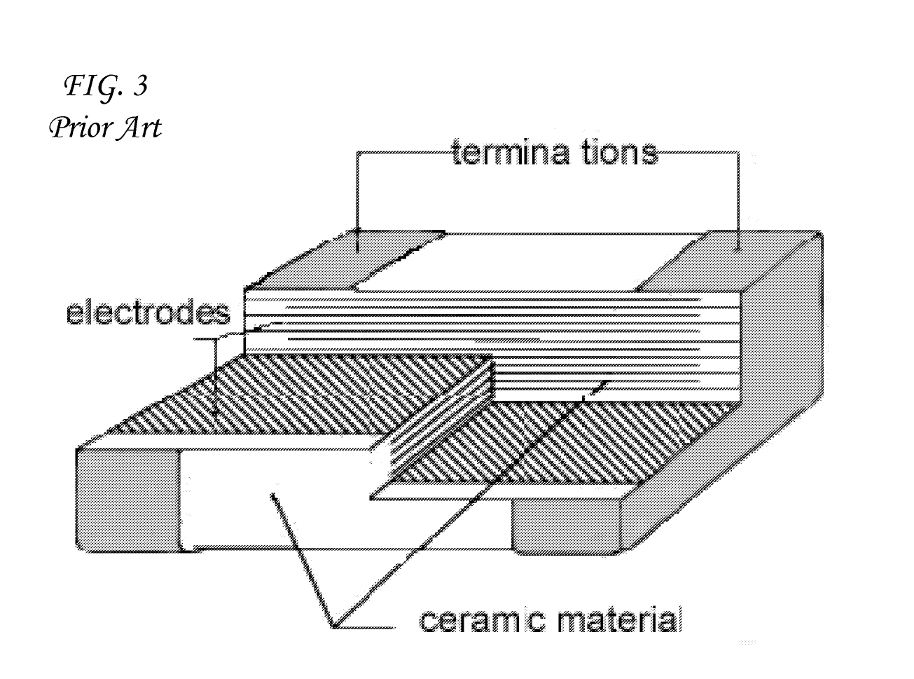

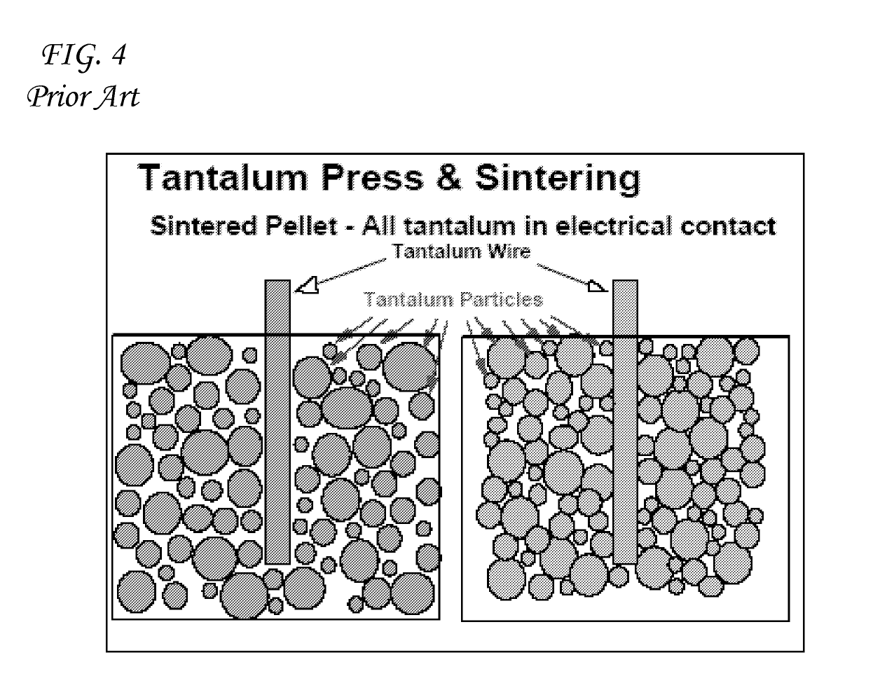

### DETAILED DESCRIPTION

The present invention addresses the deficiencies in the prior art concerning the inability to provide volumetrically efficient capacitors. Significantly, the present invention provides methods and apparatus for fabricating high-density planar capacitors. A thin film capacitor device provided in accordance with the present invention is enabled to be silicon compatible. The method of fabrication of an exemplary embodiment of the present invention involves application of a dielectric layer for a high-density capacitor with an atomic layer deposition process. Additionally, the present invention overcomes the drawbacks of the conventional methods and systems in the prior art and provides systems and methods enabled to provide high-density capacitors that can be implemented along with integrated circuit boards in a silicon stack package.

An exemplary embodiment of the present invention provides a method for fabricating a high-density capacitor system including the steps of providing a substrate and depositing a nanoelectrode particulate paste layer onto the substrate. The method for fabricating a high-density capacitor system further includes sintering the nanoelectrode particulate paste layer to form a bottom electrode. Additionally, the method for fabricating a high-density capacitor system includes depositing a dielectric material onto the bottom electrode with an atomic layer deposition process. Furthermore, the method for fabricating a high-density capacitor system includes depositing a conductive material on the dielectric material to form a top electrode.

In addition to methods for fabricating high-density capacitors, the present invention provides a high-density capacitor system including a substrate and a bottom electrode, wherein the bottom electrode is comprised of nanoelectrode particulate paste layer deposited on the substrate and sintered. The high-density capacitor system further including a dielectric material, wherein the dielectric material is deposited onto the bottom electrode with an atomic layer deposition process. Additionally, the high-density capacitor system includes a top electrode, wherein the top electrode is comprised of a conductive material on the dielectric material.

The high-density capacitor systems enabled by the present invention present significant advantages to biomedical applications, such as biomimetic implants and biomedical neural stimulators. Because the high-density capacitor systems enabled by the present invention provide significant advancements in both volumetric efficiency and capacitance density, they can provide the necessary capacitor components for a miniaturized biomedical implant and also meet the geometric constraints of the application. In addition to biomedical applications, the high-density capacitor systems enabled by the present invention can be implemented in almost any application that demands a relatively high amount of current in short intervals. For example, and not limitation, an exemplary embodiment of the high-density capacitor system can be implemented in a low impedance power supply to assist with noise suppression. In another non-limiting example, an exemplary embodiment of the high-density capacitor system can be used in a pulse power supply to assist in providing sudden bursts of power for impulse applications such as activating the flash on a digital camera or accessing a memory stick of a portable memory device. Additionally, an exemplary embodiment of the high-density capacitor system can be implemented in power conversion applications to step-up and/or step-down voltages, such as stepping-down the voltage from a 5V circuit to a 3.3V circuit. Furthermore, an exemplary embodiment of the high-density capacitor system could be used in conjunction with a high-speed microprocessor as a decoupling device.

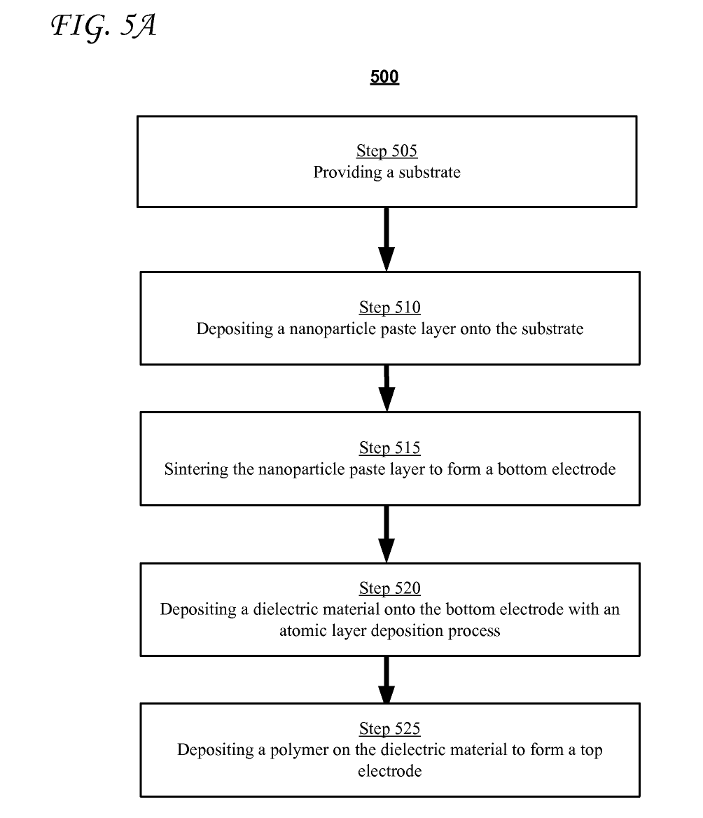

FIG. 5A provides an illustration of a block diagram of the method for fabricating a high-density capacitor system 500 in accordance with an exemplary embodiment of the present invention. As shown in FIG. 5A, the first step 505 of an exemplary embodiment of the method for fabricating a high-density capacitor system 500 involves providing a substrate. This substrate can be a silicon substrate or other silicon compatible material. The second step 510 of an exemplary embodiment of the method for fabricating a high-density capacitor system 500 involves depositing a nanoelectrode particulate paste layer onto the substrate. In an exemplary embodiment, the nanoelectrode particulate paste contains a mixture both conductive nanoelectrode particulate components and polymers. The term “nanoelectrode particulate” is used herein to refer to elements comprising metal particles, diatoms, and/or ceramic particles or a combination thereof. This paste mixture, used in an exemplary embodiment of the method for fabricating a high-density capacitor system 500, permits the application to the substrate and aids in fabrication of a porous bottom electrode layer. The third step 515 of an exemplary embodiment of the method for fabricating a high-density capacitor system 500 involves sintering the nanoelectrode particulate paste layer to form a bottom electrode. This sintering step 520 can enable the removal of the polymer contained in the mixture of the nanoparticle paste in an exemplary embodiment of the method for fabricating a high-density capacitor system 500. Furthermore, in an exemplary embodiment the sintering step 520 involves heating the nanoparticle paste to a temperature below its melting point so that the nanoparticle electrodes contained in the nanoparticle paste adhere to each other. Thus, the sintering step 520 in an exemplary embodiment can promote mechanical integrity and structural cohesiveness with the nanoparticle electrodes contained within the paste. This third step 515 of sintering in an exemplary embodiment is performed at temperatures that are compatible with silicon. For example, and not limitation, the sintering step 520 can be carried out at temperatures below 1300 C for silicon substrates. In alternative embodiment, in which the substrate is comprised of ceramic, sintering step 520 can be carried out at temperatures below 2000 C.

In an exemplary embodiment of the method for fabricating a high-density capacitor system 500, the porosity of the resulting nanoelectrode particulate layer forming the bottom electrode can be controlled by adding specific pore-generating polymers to create a designed hierarchical porous structure. In additional alternative embodiments, techniques other than particle sintering can be used to create the porous nanoelectrode structure. In one alternative embodiment, the porous structure of nanoelectrode particulate of the bottom electrode is created by melt processes, which utilizes sacrificial materials among the nanoelectrode particulate or gas injection to create the porous structure. In yet another embodiment, other porous nanoelectrode particulate based on diatom frustules can also be implemented in the method for fabricating a high-density capacitor system 500 to provide the porous layer of nanoelectrode particulate to form the bottom electrode.

In an exemplary embodiment of the method for fabricating a high-density capacitor system 500, the fourth step 520 can involve depositing the dielectric material such that it is highly conformal to the nanoelectrode particulate paste layer. A highly conformal dielectric material can result in high insulation resistance coating. The ability of the dielectric material to provide a relatively high insulation coating enables an exemplary embodiment of the high-density capacitor system 600 to provide a more efficient energy storage area in which a relatively high amount of charge may be stored at a given energy level; thus, providing a more ideal capacitor.

In an exemplary embodiment of the method for fabricating a high-density capacitor system 500, the dielectric material is deposited on the nanoelectrode particulate paste layer with an atomic layer deposition process 520. This atomic layer deposition process 520 in an exemplary embodiment can enable a self-limiting growth mechanism for highly controlled and precise deposition of dielectric material. The principle of atomic layer deposition is based on sequential pulsing of special precursor vapors, which form one atomic layer pulse. The term precursor is used to refer to many suitable types of substances including water. Additionally, although vapor deposition is referenced in some embodiments, the method for fabricating a high-density capacitor system 500 also contemplates atomic layer deposition by immersion. Each pulse of an exemplary embodiment of the atomic layer deposition process 520 can form one layer of the dielectric material. An exemplary embodiment of the atomic layer deposition process 520 can enable dielectric material fabrication with pinhole free coatings that are highly uniform in thickness, even deep inside pores, trenches and cavities. Those of skill in the art will appreciate that there a number of suitable implementations of the atomic layer deposition process 520 that can be used without detracting from the scope of the method for fabricating a high-density capacitor system 500.

In one embodiment, atomic layer deposition process 520 involves a cyclical four-step process. The first step involves exposure of the newly formed bottom electrode to a first precursor and the second step involves a cleanse or purge of a reaction chamber. The term reaction chamber is used herein to refer to both vapor based reaction chambers and solution based reaction chambers. Furthermore, the third step involves the exposure of a second precursor, and the fourth step involves a further cleanse of the reaction chamber. Each reaction cycle of an exemplary embodiment of the atomic layer deposition process 520 adds a given amount of material to the surface. To grow a material layer, the reaction cycles of an exemplary embodiment of the atomic layer deposition process 520 can be repeated as many as required for the desired film thickness. In this embodiment, the precursor molecules chemisorb or react with surface groups until the chemisorption is saturated. Under these saturative reaction conditions in this embodiment, the film growth is self-limiting because no further adsorption takes place. Thus, in this embodiment of the atomic layer deposition process 520, the amount of film material deposited in each reaction cycle can be constant. Those of skill in the art will appreciate that atomic layer deposition process 520 can be self-limiting as the amount of film material deposited in each reaction cycle can be constant. Thus, the atomic layer deposition process 520 provides a sequential surface chemistry that deposits conformal thin-films of materials onto substrates of varying compositions. An exemplary embodiment of the atomic layer deposition process 520 is similar in chemistry to chemical vapor deposition (“CVD”) process, except that an exemplary embodiment of the atomic layer deposition process 520 breaks the CVD reaction into two half-reactions, keeping the precursor materials separate during the reaction. Due to the characteristics of self-limiting and surface reactions, an exemplary embodiment of the atomic layer deposition process 520 can provide dielectric material film growth with atomic scale deposition control. By keeping the precursors separate throughout the coating process, in an exemplary embodiment of the atomic layer deposition process 520, atomic layer control of film growth can be obtained as fine as ˜0.1 Å (10 pm) per monolayer.

Those of skill in the art will appreciate that the atomic layer deposition process can vary depending upon the dielectric material used. For example, and not limitation, for higher k films, such as multiple component oxides like strontium titanate (STO), three set of precursors are needed. For other types of dielectric material, only two different precursors are needed, one for the metal precursor and the other for hydroxylation. In certain embodiment, the dielectric material deposition rate and quality of the dielectric material layer formed can be dependent on the pulsing rate of strontium and titanate precursors.

Alternate techniques such as anodization can be used in alternative embodiments of the method for fabricating a high-density capacitor system 500 to also used to deposit the dielectric material. In some embodiments implementing anodization, certain class of metals such as aluminum, tantalum, niobium etc. are more suitable. In other embodiments of the method for fabricating a high-density capacitor system 500, various surface reaction based techniques based on solution and vapor are also suitable for depositing a conformal coating of dielectric material on the bottom electrode of porous nanoelectrode particulate. Those of skill in the art will appreciate that there are a variety of suitable surface reaction techniques, including those described in US Patent Publication No. 2006/0269762, incorporate by reference as if fully set forth herein. These are covered in the previous patent invention of the authors [application Ser. No. 11/363,334]. The conformal atomic layer deposition techniques can also be done in solution phase with a sequence of surface hydrolysis steps inside a solution. These techniques can also be effectively used for forming the conformal coatings.

The fifth step 525 of an exemplary embodiment of the method for fabricating a high-density capacitor system 500 involves depositing a conductive material on the dielectric material to form a top electrode. The conductive material can be a variety of suitable materials, such as metals and polymers. In an exemplary embodiment, the method for fabricating a high-density capacitor system 500 can further include the step of providing a conductive pad in communication with the top electrode.

Several other alternatives can implemented in the fifth step 525 of an exemplary embodiment of the method for fabricating a high-density capacitor system 500 to form the top electrode of the capacitor system. In one embodiment, the fifth step 525 involves solution-derived techniques. In this solution reduction based embodiment, metal precursor solutions can be infiltrated into the nanoelectrode structure. These solutions can be then reduced in the gas phase using a solgel technique, such as the one described in US Patent Publication No. 2005/0274227 incorporated herein by reference as if fully set forth below. Yet another embodiment implements vapor-derived conductive coating techniques in the fifth step 525. Alternately, solution reduction techniques or the electroless metallization, chemical plating processes can also be used to form the top electrode in various embodiments of the method for fabricating a high-density capacitor system 500. Additionally, the fifth step 525 of top electrode formation can be implemented with vapor deposition techniques such as ALD and CVD.

In an alternative embodiment, the method for fabricating a high-density capacitor 500 includes implementing the high-density capacitor in a silicon stack package. An exemplary embodiment of the high-density capacitor created by the method for fabricating a high-density capacitor system 500 is a silicon compatible capacitor that can be connected to an integrated circuit layer. Therefore, the high-density capacitor system 500 can include the step of providing conductive pads enabled to be connected to an integrated circuit layer, board, or planar member.

FIG. 5B provides an illustration of a block diagram of the fourth step 520 of an exemplary embodiment of the method for fabricating a high-density capacitor system 500 involving depositing a dielectric material onto the bottom electrode. In the exemplary embodiment of the fourth step 520 involving depositing a dielectric material onto the bottom electrode, an atomic layer deposition process is used. As diagramed in FIG. 5B, an exemplary embodiment of the atomic layer deposition process 520 first involves the step 520A of placing the bottom electrode of a partially fabricated high-density capacitor system 600 into a reaction chamber. Then, in the second step 520B, the bottom electrode is exposed to a first precursor. The second step 520B can be configured to occur for predetermined period of time. In the third step 520C of an exemplary embodiment of the atomic layer deposition process 520, the reaction chamber is cleansed of the first precursor. In the fourth step 520D of an exemplary embodiment of the atomic layer deposition process, the bottom electrode is exposed to a second precursor. Similar to the second step 520B, the fourth step 520D can be configured to occur for predetermined period of time. Once the bottom electrode has been exposed to the second precursor for a predetermined period of time, the reaction chamber can be cleansed of the second precursor in the fifth step 520E of an exemplary embodiment of the atomic layer deposition process 520. In an exemplary embodiment of the atomic layer deposition process 520, the second through fifth steps can be repeated in accordance with a desired dielectric material layer. Each exposure of the precursor, steps 520B and 520D, in an exemplary embodiment of the atomic layer deposition process 520 corresponds to an atomic layer pulse and can result in the formation of one layer of the dielectric material. Therefore, in accordance with an exemplary embodiment, very precise deposition of the dielectric material onto the bottom electrode of the high-density capacitor system 600 can be accomplished. The exemplary embodiment of the atomic layer deposition process 520 can repeat, 530, until the desired thickness of the dielectric material on the bottom electrode of the high-density capacitor system 600 is achieved.

The exemplary embodiment of the atomic layer deposition process 520 shown in FIG. 5B utilizes two precursors. Those of skill in the art will appreciate that a variety of atomic layer deposition processes 520 can be implemented in various embodiments of the method for fabricating a high-density capacitor system 500 in which not only different types of precursors are used, but different numbers of precursors. Some embodiments, for example, can use three different precursors in three independent reaction cycles.

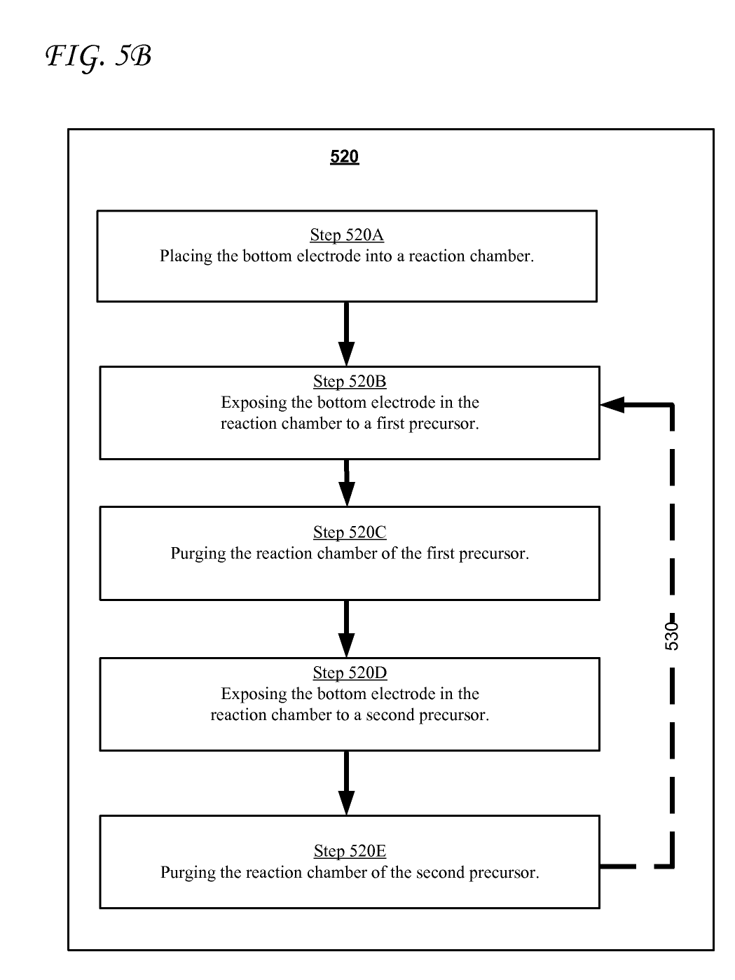

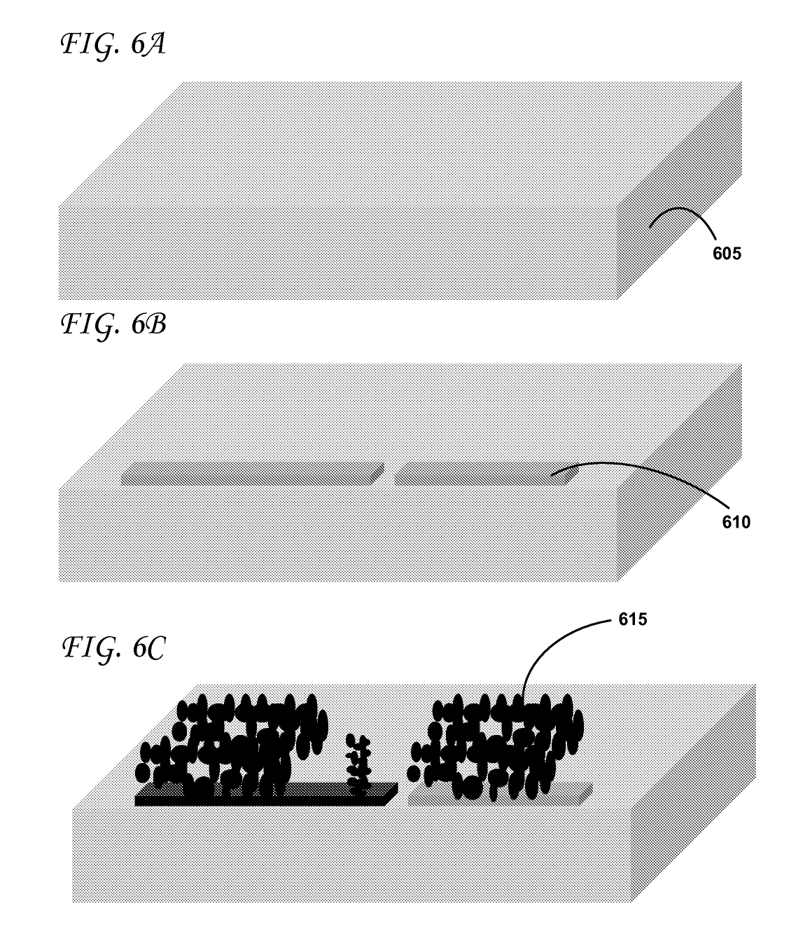

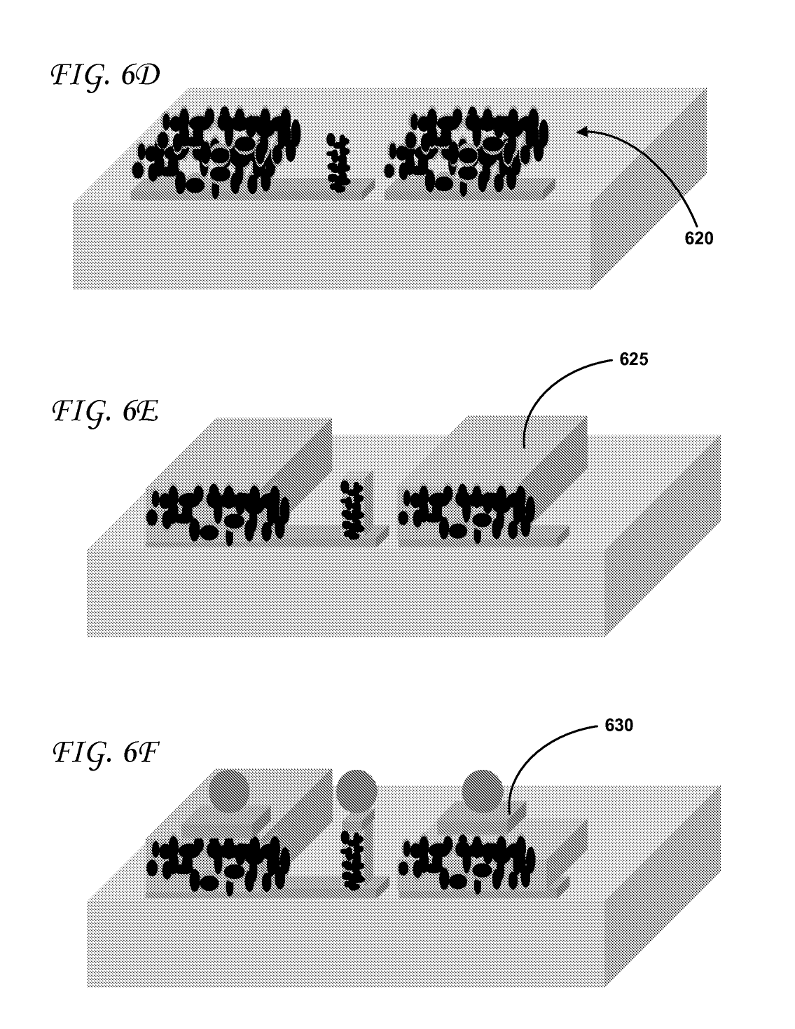

FIGS. 6A-6F provide an illustration of high-density capacitor system 600 created by the method for fabricating a high-density capacitor system 500 in accordance with an exemplary embodiment of the present invention. As shown in the exemplary embodiment in FIG. 6A, the first step in the creation of the high-density capacitor system 600 in accordance with an exemplary embodiment of the method for fabricating a high-density capacitor system 500 involves providing a substrate. In an exemplary embodiment, this substrate layer 605 can be comprised of silicon or other suitable types of silicon compatible materials.

As shown in FIG. 6B, some embodiments of the high-density capacitor system 600 can include a trace conductive layer 610. In one embodiment, this trace conductive layer 610 can be comprised of copper. The trace conductive layer 610 in an exemplary embodiment can provide a foundation for the trace of the capacitor component array to be fabricated upon the substrate 605. In alternative embodiments of the high-density capacitor system 600, this trace conductive layer 610 is not required.

FIG. 6C provides an illustration of the fabrication of the nanoelectrode particulate paste layer 615 of a high-density capacitor system 600 in accordance with an exemplary embodiment of the method for fabricating a high-density capacitor system 500. As shown in the exemplary embodiment in FIG. 6C, the nanoelectrode particulate paste layer 615 can be deposited onto the trace conductive layer 610 on the substrate 605. In an alternative embodiment that does not provide a trace conductive layer 610, the nanoelectrode particulate paste layer 615 can be directly deposited onto the substrate 605. Once the nanoelectrode particulate paste layer 615 is deposited on the substrate 605, in an exemplary embodiment of the method for fabricating a high-density capacitor system 500, it can be sintered to form the bottom electrode of the high-density capacitor system 600. This nanoelectrode particulate paste layer 615 can comprised of a material with a low temperature sinterable base metal or valve metal in an exemplary embodiment of the high-density capacitor system 600 in order to be silicon compatible. In an exemplary embodiment, the nanoelectrode particulate paste layer 615 can be comprised of a base metal, such as copper, nickel, or a valve metal, such as titanium or tantalum.

In an exemplary embodiment of the high-density capacitor system 600, the nanoelectrode particulate paste layer 615 can be comprised of a paste that can be effectively applied to the substrate 605. In an exemplary embodiment, the nanoelectrode particulate paste layer 615 is comprised of nanoelectrode particulate that provides a relatively high surface area. More particularly, the porous nature of the formation of the nanoelectrode particulate from the nanoelectrode particulate paste layer 615, in an exemplary embodiment, provides a conductive layer with a significantly enhanced surface area. The highly porous and contoured nature of the bottom electrode in an exemplary embodiment provides a jagged structure with significantly enhanced three-dimensional surface contours. In comparison to conventional trench capacitors, the tortuous nature of the bottom electrode provides what can be compared to a large number of trenches in a conventional trench capacitor. The significantly enhanced three-dimensional surface contours of the bottom electrode greatly increases the area-enhancement factor of the exemplary embodiment of the high-density capacitor system 600; thus, increasing the capacitance density of the high-density capacitor system 600. An increase in the area-enhancement factor can yield higher capacitance densities because the tortuous nature of the surface contours of the bottom electrode increase the effective electrode area without increasing the area occupied by the electrode on the substrate 605. Therefore, the surface area of the bottom electrode is greatly increased, without an increase in the surface area of the substrate 605. In an exemplary embodiment, the porosity can be controlled by introducing pore-generating polymers, where the polymers can be in a solution, emulsion or granules. In the exemplary embodiment relying upon emulsions and granules, the porosity of the porous conductive layer can be controlled by the polymer size distribution.

FIG. 6D provides an illustration of the fabrication of the dielectric material 620 of a high-density capacitor system 600 in accordance with an exemplary embodiment of the method for fabricating a high-density capacitor system 500. The dielectric material 620 in an exemplary embodiment of the high-density capacitor system 600 can be a material with relatively high insulation resistance and moderate permittivity. Furthermore, the dielectric material 620 in an exemplary embodiment can have a relatively low voltage coefficient of permittivity, low temperature coefficient of permittivity, low voltage derating beyond 85° C., better intrinsic electrical reliability because of lower susceptibility to defects such as vacancies and interfacial traps, and low temperature processing so that electrodes and interfaces are stable during the deposition process. In some embodiments, the dielectric material 620 can be multicomponent oxides. For example, and not limitation, the dielectric material 620 in one embodiment can be alumina, titania, hafnium oxide, zirconia, silicon oxyntrides, tantalum oxide, barium titanate or strontium titanate and other binary and ternary oxides.

In an exemplary embodiment of the method for fabricating a high-density capacitor system 500, the dielectric material 620 can be deposited such that it is highly conformal to the undulating and tortuous bottom electrode formed from the nanoelectrode particulate paste layer 615. A highly conformal dielectric material 620 can result in high insulation resistance coating. The ability of the dielectric material 620 to provide a relatively high insulation coating enables an exemplary embodiment of the high-density capacitor system 600 to provide a more efficient energy storage area in which a relatively high amount of charge may be stored at a given energy level; thus, providing a more ideal capacitor.

In an exemplary embodiment of the method for fabricating a high-density capacitor system 500, the dielectric material 620 is deposited on the nanoelectrode particulate paste layer 615 with an atomic layer deposition process. This atomic layer deposition process can enable a self limiting growth mechanism for highly controlled and precise deposition of dielectric material 620. The principle of atomic layer deposition is based on sequential pulsing of special precursor vapors, which form one atomic layer pulse. Each pulse of the atomic layer deposition process can form one layer of the dielectric material 620. Atomic layer deposition techniques can enable dielectric material 620 fabrication with pinhole free coatings that are highly uniform in thickness, even deep inside pores, trenches and cavities. Those of skill in the art will appreciate that there a number of suitable implementations of the atomic layer deposition process can be used without detracting from the scope of the method for fabricating a high-density capacitor system 500.

In an exemplary embodiment, the dielectric layer can also be formed by various methods such as Atomic Layer Deposition (ALD) with vapors or solutions where dielectric formation is obtained by sequential solution reactions with different precursors. One such example for solution based atomic layer deposition involves surface hydrolysis and precursor condensation on the hydrolyzed surface to form a monolayer by solution immersion. In an alternative embodiment, this same technique can be extended to electrochemical atomic layer deposition in which surface solution reactions are aided by applying an electrochemical potential to the nanoelectrode. In other embodiments, the dielectric material 620 can also be formed by anodization with certain nanoelectrode particulate such as aluminum, tantalum, titanium, niobium.

FIG. 6E provides an illustration of the fabrication of the conductive material 625 of a high-density capacitor system 600 in accordance with an exemplary embodiment of the method for fabricating a high-density capacitor system 500. The conductive material 625 of an exemplary embodiment of the high-density capacitor system 600 can be fabricated onto the dielectric material 620 layer to form the top electrode of the high-density capacitor system 600. The conductive material 625 in some embodiments can be a highly doped conductive polymer with improved conductivity. In an exemplary embodiment, the conductive polymer of the conductive material 625 can be in-situ polymerized or prepolymerized and dispensed as nanodispersions. Those of skill in the art will appreciate that the prepolymerized polymers of an exemplary embodiment can be free of reactive species that are more inert to the ALD films. Furthermore, those of skill in the art will appreciate that in-situ polymerization can sometimes result in acidic solutions that are reactive, and more penetrating into the nanoelectrodes particulate.

In an exemplary embodiment, the conductive material 625 can be a titanium nitride and doped polysilicon. Alternative embodiments for forming the conductive material 625 are the solution derived solid conducting layers processes such as gas phase reduction or solution reduction processes. In an alternative embodiment, electroless plating and chemical plating are examples of solution reduction processes. In order to be compatible with silicon stacking, an exemplary embodiment of the conductive material 625 must be resistant to cracking and delamination during the silicon stack assembly and thermal cycling. Additionally, the conductive material 625 can act as a stress buffer to mitigate stress on the high-density capacitor system 600 in an exemplary embodiment. The conducting polymer 625 in an exemplary embodiment can be stable at temperatures below 500° C., have a relatively low resistivity, provide self-healing attributes, provide adequate strength and toughness to provide mechanical stability, and be amenable to subsequent copper metallization.

FIG. 6F provides an illustration of the fabrication of the conductive pads 630 of a high-density capacitor system 600 in accordance with an exemplary embodiment of the method for fabricating a high-density capacitor system 500. These conductive pads 630 can be formed in communication with conductive material 625 of an exemplary embodiment of the high-density capacitor system 600. Those of skill in the art will appreciate that these conductive pads 630 can provide the interconnect leads to the high-density capacitor system 500. One of the significant advantages provided by an exemplary embodiment of the high-density capacitor system 600, is that the discrete capacitor components of the system 500 can have independent terminals. The conductive pads 630 shown in FIG. 6F can provide interconnects to these independent terminals of the capacitive components of an exemplary embodiment of the high-density capacitor system 600.

In some embodiments, the high-density capacitor system 600 can be connected to other chips via conventional wire bonding techniques. Alternatively, in an exemplary embodiment, the conductive pads 630 can be interconnected with other boards, such as an integrated circuit board, via microbump connections or flip chip connections. These microbumps can be solder bumps that are deposited on the conductive pads 630 of an exemplary embodiment of the high-density capacitor system 600. In an exemplary embodiment, the microbumps can be aligned so that they align with matching pads on an external circuit, such as an integrated circuit board, and then the solder can be flowed to complete the interconnection.

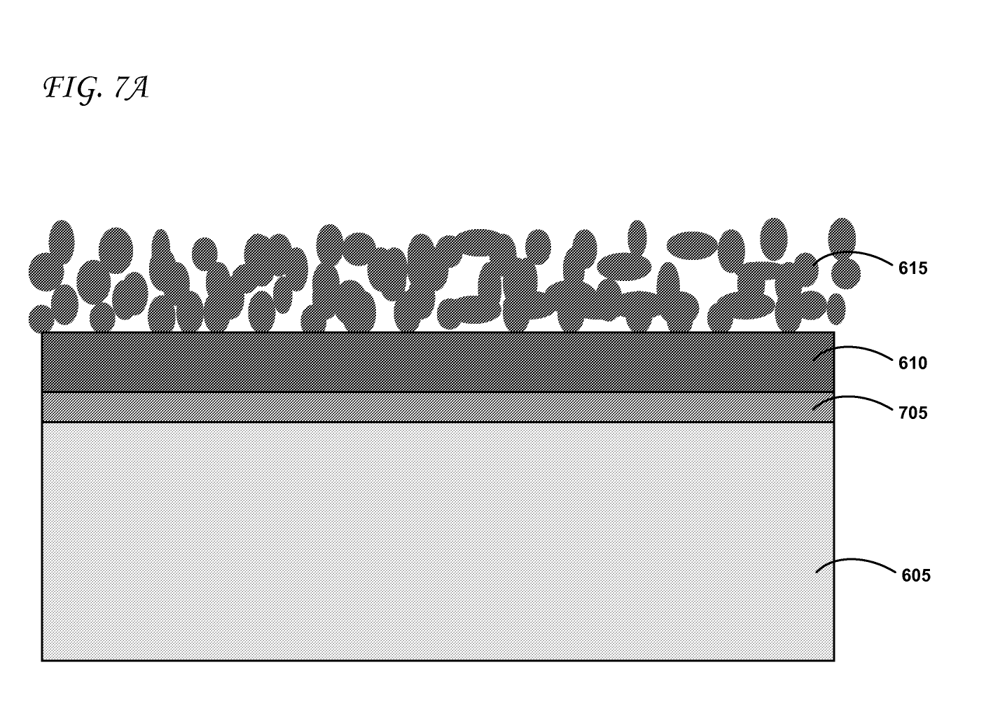

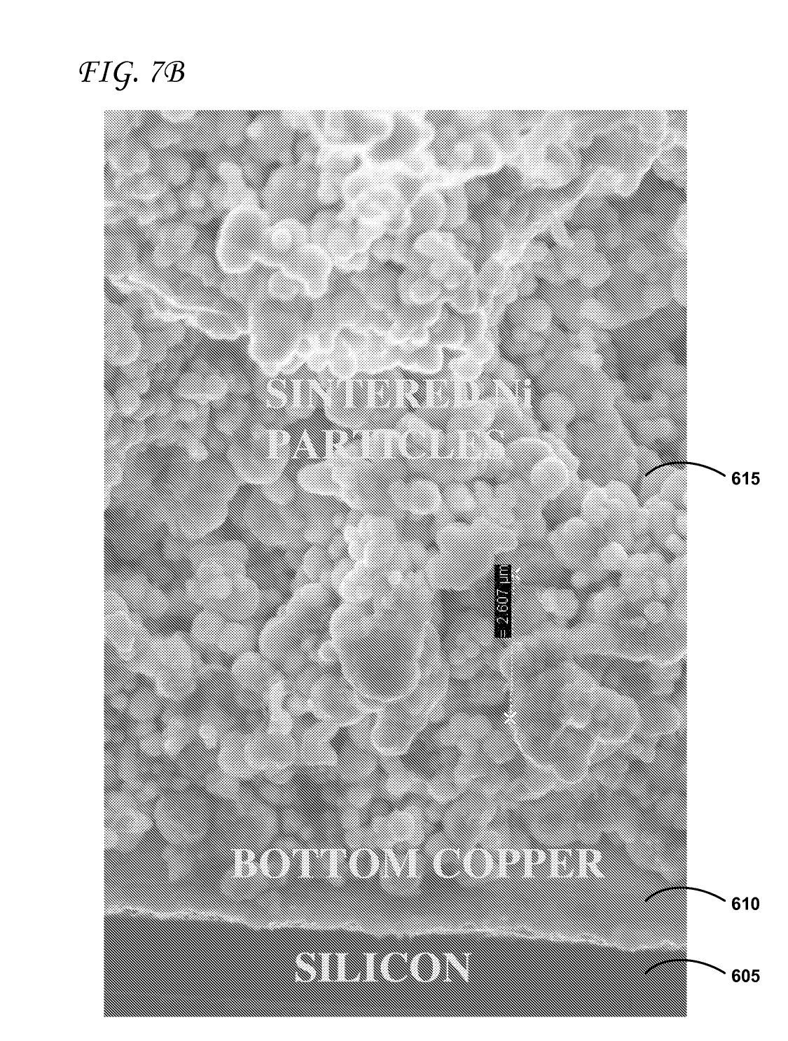

FIG. 7A provides an illustration of a partially fabricated high-density capacitor system 600 after the step of sintering the nanoelectrode particulate paste layer 615 in an exemplary embodiment of the method for fabricating a high-density capacitor system 500. As shown in FIG. 7A, the high-density capacitor system 600 can comprise four layers after the step of sintering the nanoelectrode particulate paste layer 615 in an exemplary embodiment of the method for fabricating a high-density capacitor system 500. These four layers in the exemplary embodiment of the partially fabricated high-density capacitor system 600 shown in FIG. 7A include the substrate layer 605 shown as the base of the partially fabricated high-density capacitor system 600 and an adhesion layer 705. The adhesion layer 705 can provide a substance layer that promotes attachment of the trace conductive layer 610 and/or the nanoelectrode particulate paste layer 615 in an exemplary embodiment of the present invention. The remaining layers in this exemplary embodiment include the trace conductive layer 610, deposited onto the adhesion layer 705, and the nanoelectrode particulate paste layer 615, which has been sintered to enable the removal of the polymer contained in the mixture of the nanoelectrode particulate paste.

FIG. 7A provides great perspective on the tortuous and highly contoured nature of the surface of the sintered nanoelectrode particulate paste layer 615 fabricated in accordance with an exemplary embodiment of the method for fabricating a high-density capacitor system 500. The sintered nanoelectrode particulate paste layer 615 can form the bottom electrode, and, as shown in FIG. 7A, this bottom electrode can provide a surface containing many highly contoured trenches and cavities. It is the highly contoured and tortuous nature of the bottom electrode formed by the sintered nanoelectrode particulate paste layer 615 that partially enables the relatively high area enhancement factors possible with high-density capacitor systems 600 fabricated in accordance with an exemplary embodiment of the method for fabricating a high-density capacitor system 500.

FIG. 7B provides a micrograph of a partially fabricated high-density capacitor system 600 after the step of sintering the nanoelectrode particulate paste layer 615 in an exemplary embodiment of the method for fabricating a high-density capacitor system 500. The micrograph shown in FIG. 7B illustrates an exemplary embodiment of a partially fabricated high-density capacitor system 600 having a substrate layer 605, labeled “silicon,” a trace conductive layer 610, labeled “bottom copper,” and a sintered nanoelectrode particulate paste layer 615, labeled “sintered Ni particles.” As shown in FIG. 7B, the nanoelectrode particulate paste layer 615 in an exemplary embodiment can be nickel particles, which form a highly contoured and tortuous surface for the bottom electrode. This highly contoured and tortuous surface of exemplary embodiment of the sintered nanoelectrode particulate paste layer 615 shown in FIG. 7B is highly advantageous as a interface between the bottom electrode and the dielectric material layer to provide the dielectric layer of an of the high-density capacitor system 600. Once the nanoelectrode particulate paste layer 615 has been properly sintered, in accordance with an exemplary embodiment of the method for fabricating a high-density capacitor system 500, the dielectric layer can be deposited onto the bottom electrode.

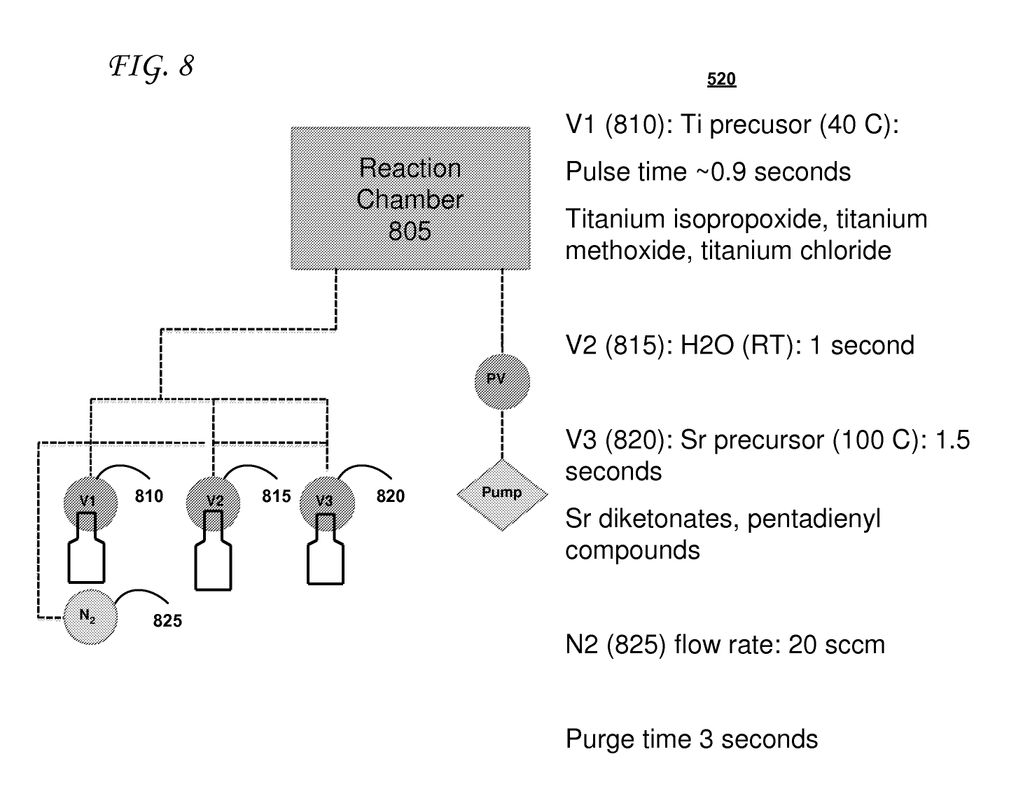

FIG. 8 provides an illustration of an atomic layer deposition process 520 in an exemplary embodiment of the method for fabricating a high-density capacitor system 500. The atomic layer deposition process 520 shown in FIG. 8 involves a cyclical process with three reaction cycles, including a titanium precursor, a water precursor, and a strontium precursor. As shown in FIG. 8, this embodiment of the atomic layer deposition process 520 relies upon a reaction chamber 805. The reaction chamber 805 is used to house the one or more partially fabricated high-density capacitor systems 600 having a bottom electrode onto which the dielectric material can be formed. Once one or more of the partially fabricated high-density capacitor systems 600 have been placed in the reaction chamber 805, the reaction cycles can begin. In the first reaction cycle of an exemplary embodiment of the atomic layer deposition process 520, the first volume (“V1”) 810 containing the titanium precursor (at 40° C.) is opened to the reaction chamber 805. The titanium precursor can be exposed in the reaction chamber 805 for a predetermined period of time, and in this embodiment, the titanium precursor is exposed for a pulse time of 0.9 seconds. In the exemplary embodiment of the atomic layer deposition process 520 shown in FIG. 8, a carrier gas supply 825, such as nitrogen gas at a flow rate of 20 sccm, can be supplied to carry the precursors into the reaction chamber 805. After the pulse time expires, the exemplary embodiment of the atomic layer deposition process 520 cleanses the reaction chamber 805 of the titanium precursor for a predetermined period of time, such as 3 seconds

In the second reaction cycle of the exemplary embodiment of the atomic layer deposition process 520 shown in FIG. 8, the second volume (“V2”) 815 containing the water precursor (at room temperature) is opened to the reaction chamber 805 for a predetermined pulse time, in this embodiment, a pulse time of one second. After the pulse time expires, the exemplary embodiment of the atomic layer deposition process 520 cleanses the reaction chamber 805 of the water precursor for a predetermined period of time, such as 3 seconds.

In the third reaction cycle of the exemplary embodiment of the atomic layer deposition process 520 shown in FIG. 8, the third volume (“V3”) 820 containing the strontium precursor (at 100° C.) is opened to the reaction chamber 805 for a predetermined pulse time, in this embodiment, a pulse time of one and half seconds. After the pulse time expires, the exemplary embodiment of the atomic layer deposition process 520 cleanses the reaction chamber 805 of the strontium precursor for a predetermined period of time, such as 3 seconds.

The exposure and cleanse process to the three precursors in the exemplary embodiment of the atomic layer deposition process 520 shown in FIG. 8 can be repeated in a sequential nature. The exemplary embodiment of the atomic layer deposition process 520 can repeat until a desired thickness of the dielectric material is achieved on the bottom electrode of the exemplary embodiment of the high-density capacitor system 600.

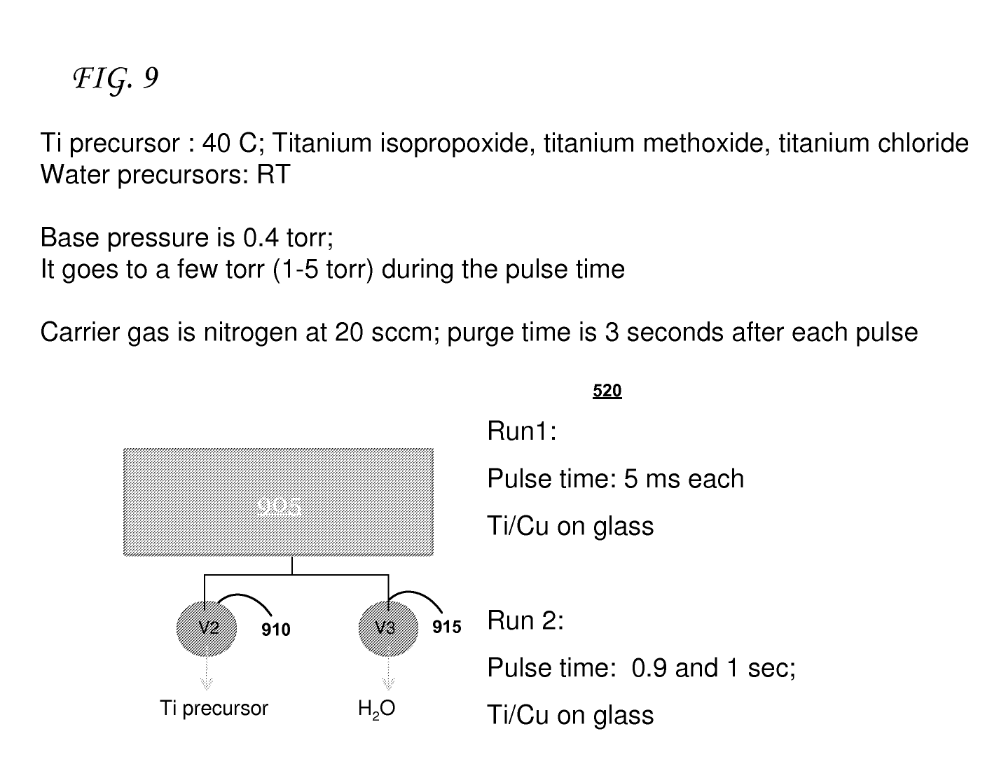

FIG. 9 provides an illustration of an atomic layer deposition process 520 in an exemplary embodiment of the method for fabricating a high-density capacitor system 500. The atomic layer deposition process 520 shown in FIG. 9 involves a cyclical process with two reaction cycles, including a titanium precursor and a water precursor. As shown in FIG. 9, this embodiment of the atomic layer deposition process 520 relies upon a reaction chamber 905. The reaction chamber 905 is used to house the one or more partially fabricated high-density capacitor systems 600 having a bottom electrode onto which the dielectric material can be formed. Once one or more of the partially fabricated high-density capacitor systems 600 have been placed in the reaction chamber 905, the reaction cycles can begin. In the first reaction cycle, the first volume (“V2”) 910 containing the titanium precursor (at 40° C.) can be opened to the reaction chamber 905. The titanium precursor can be exposed in the reaction chamber 905 for a predetermined period of time. In the exemplary embodiment of the atomic layer deposition process 520 shown in FIG. 9, a carrier gas, such as nitrogen gas at a flow rate of 20 sccm, can be supplied to carry the gas into the reaction chamber 905. After the pulse time expires, the exemplary embodiment of the atomic layer deposition process 520 cleanse the reaction chamber 805 of the titanium precursor for a predetermined period of time, such as 3 seconds.

In the second reaction cycle of the exemplary embodiment of the atomic layer deposition process 520 shown in FIG. 9, the second volume (“V3”) 915 containing the water precursor (at room temperature) is opened to the reaction chamber 905 for a predetermined pulse time. After the pulse time expires, the exemplary embodiment of the atomic layer deposition process 520 cleanses the reaction chamber 905 of the water precursor for a predetermined period of time, such as 3 seconds.

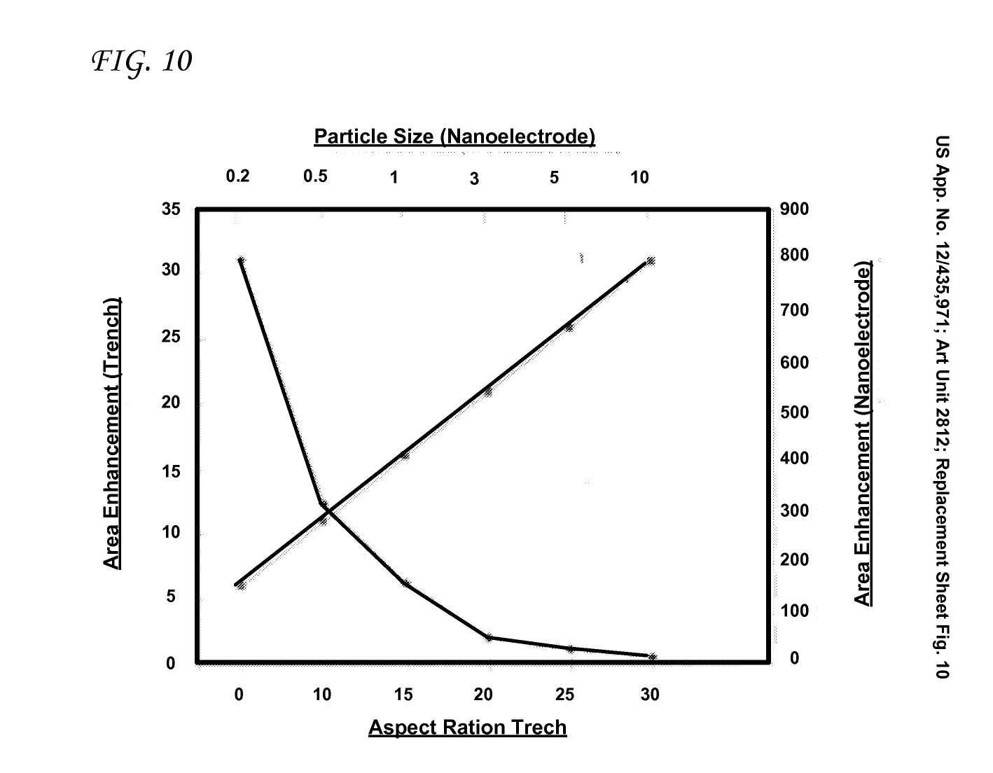

FIG. 10 provides a graphical comparison of the area enhancement factor and aspect ratios associated with exemplary embodiments of the high-density capacitor system 600 and conventional trench capacitors. As shown in the graph in FIG. 10, the area enhancement factor for conventional trench capacitors is significantly less than the area enhancement factor for a high-density capacitor system 600 fabricated in accordance with an exemplary embodiment of the present invention. For example, the conventional trench capacitors graphed in FIG. 10 exhibited an area enhancement factor of between 25 and 30, while the exemplary embodiments of the high-density capacitor systems 600 can exhibit an area enhancement factor of greater than 40, such as between 500 and 700.

A high-density capacitor system 600 provided in accordance with an exemplary embodiment of method for fabricating a high-density capacitor system 500 the present invention provides a volumetric efficiency that is superior to conventional capacitor designs. For example, an exemplary embodiment of the high-density capacitor system 600 can provide a capacitance density of greater than 50 μF/cm² and even greater than 100 μF/cm in some embodiments. Furthermore, an exemplary embodiment of the method for fabricating a high-density capacitor system 500 enables the creation a highly thin and planar device. In an exemplary embodiment, the high-density capacitor system 600 can have a thickness, including the substrate layer 605, of less than 500 μm and in some embodiments less 300 μm.

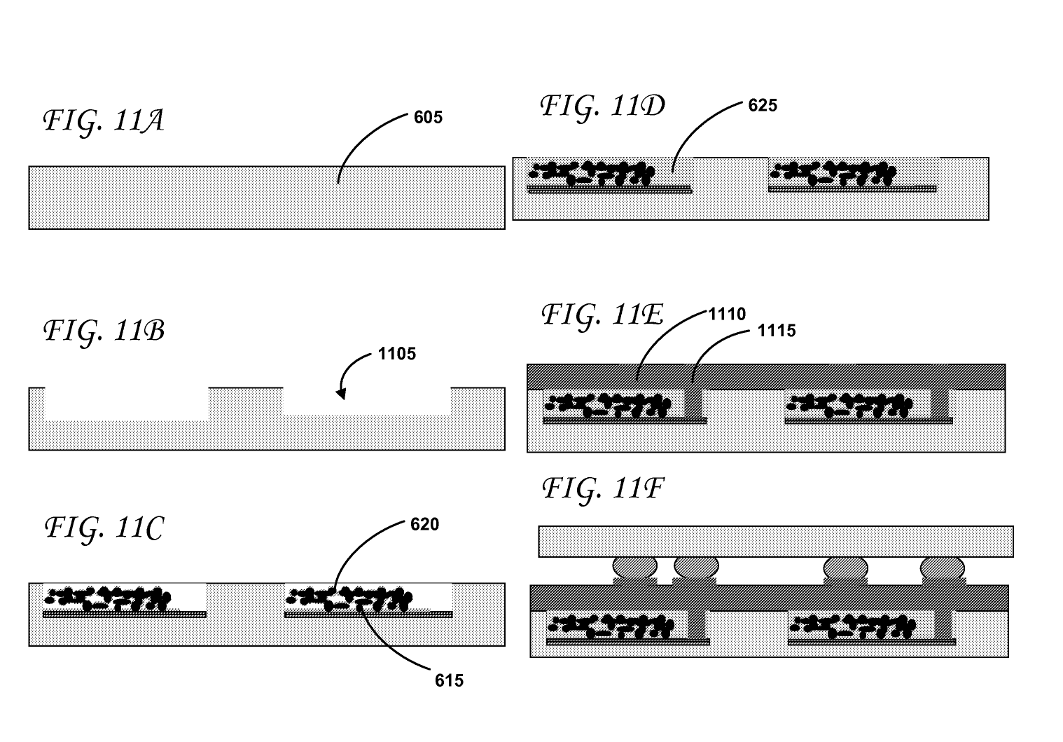

FIGS. 11A-11F provide an illustration of a high-density capacitor system 600 created by the method for fabricating a high-density capacitor system 500 in accordance with an exemplary embodiment of the present invention, in which the high-density capacitor system 600 can be made by creating troughs 1105 in the substrate layer 605 through etching. In an exemplary embodiment, as shown in FIG. 11B, the troughs 1105 can be created in the substrate layer 605 by a wet or dry etching process. Those of skill in the art will appreciate that the substrate layer 605, of the high-density capacitor system 600 exemplary embodiment having trough 1105, can be variety of different materials suitable for etching such as silicon or glass. As shown in FIG. 11C and 11D, in an exemplary embodiment the nanoelectrode particulate paste layer 615 forming the bottom electrode and the dielectric material 620 can be formed inside the trough 1105. Furthermore, the top and bottom electrodes formed in an exemplary embodiment of the high-density capacitor system 600 can provide external connections through vias 1110 and 1115, as shown in FIG. 11E.

In an exemplary embodiment, and the conductive material 625 forming the top electrode can be dispensed within the troughs 1105 and enable self-patterning of the top electrode giving precise control in geometry. In accordance with an exemplary embodiment, the total thickness of the high-density capacitor system 600 can be reduced by fabricating a majority of the system 600 inside the troughs 1105.

In an exemplary embodiment, the troughs 1105 form a predetermined pattern on the substrate layer 605. This predetermined pattern can then enable the bottom electrode of the nanoelectrode particulate 615 to be formed in a predetermined pattern, in an exemplary embodiment. The ability to form the bottom electrode on the substrate layer 605 in specified predetermined pattern enables numerous benefits. First, the pattern for an exemplary embodiment of the bottom electrode can be configured in accordance with the capacitor requirements for a given implementation, device, or product. Second, the pattern for the exemplary embodiment of the bottom electrode can be configured so that the capacitive components created can be connected to independent terminals and be independently addressable.

While the invention has been disclosed in its preferred forms, it will be apparent to those skilled in the art that many modifications, additions, and deletions can be made therein without departing from the spirit and scope of the invention and its equivalents as set forth in the following claims.

What is claimed is:

1. A method for fabricating a high-density capacitor system comprising:
providing a substrate;
depositing a nanoelectrode particulate paste layer onto the substrate;
sintering the nanoelectrode particulate paste layer to form a bottom electrode;
depositing a dielectric material onto the bottom electrode with an atomic layer deposition process; and
depositing a conductive material on the dielectric material to form a top electrode.

2. The method for fabricating a high-density capacitor system of claim 1, wherein the area enhancement factor for the high-density capacitor system is greater than around 40.

3. The method for fabricating a high-density capacitor system of claim 2, wherein the area enhancement factor for the high-density capacitor system is greater than around 90.

4. The method for fabricating a high-density capacitor system of claim 1, further comprising depositing a trace conductive layer onto the substrate.

5. The method for fabricating a high-density capacitor system of claim 1, further comprising forming a conductive pad in communication with the top electrode.

6. The method for fabricating a high-density capacitor system of claim 5, further comprising placing the conductive pad in communication with a trace on an integrated circuit layer.

7. The method for fabricating a high-density capacitor system of claim 1, wherein the atomic layer deposition process involves exposure of the bottom electrode to at least two precursors.

8. The method for fabricating a high-density capacitor system of claim 1, wherein wherein the high-density capacitor system provides a capacitance density of greater than 40 μF/cm².

9. The method for fabricating a high-density capacitor system of claim 1, wherein the high-density capacitor system has a thickness of less than 500 μm.

10. The method for fabricating a high-density capacitor system of claim 1, wherein the nanoelectrode particulate paste layer is deposited in a trough in the substrate.

11. The method for fabricating a high-density capacitor system of claim 1, wherein the nanoelectrode particulate paste layer, the dielectric material, and the conductive material are deposited in a trough in the substrate.

12. A method for fabricating a high-density capacitor system comprising:
providing a substrate;
depositing a nanoelectrode particulate paste layer onto the substrate;
sintering the nanoelectrode particulate paste layer to form a bottom electrode;
depositing a dielectric material onto the bottom electrode with an atomic layer deposition process comprising,
placing the bottom electrode into a reaction chamber;
exposing the bottom electrode to a first precursor;
cleaning the reaction chamber of the first precursor;
exposing the bottom electrode to a second precursor;
cleaning the reaction chamber of the second precursor; and
depositing a conductive material on the dielectric material to form a top electrode.

13. The method for fabricating a high-density capacitor system of claim 12, wherein the first precursor is comprised of water, titanium, strontium, hafnium, silicon, zirconium, aluminum, or tantalum.

14. The method for fabricating a high-density capacitor system of claim 12, wherein the second precursor is comprised of water, titanium, strontium, hafnium, silicon, zirconium, aluminum, or tantalum.

15. The method for fabricating a high-density capacitor system of claim 12, wherein the high-density capacitor system has a thickness of less than 500 μm.

16. The method for fabricating a high-density capacitor system of claim 12, wherein the area enhancement factor for the high-density capacitor system is greater than around 90.

17. A high-density capacitor system comprising:
a substrate;
a bottom electrode, wherein the bottom electrode is comprised of nanoelectrode particulate paste layer deposited on the substrate and sintered;
a dielectric material, wherein the dielectric material is deposited onto the bottom electrode with an atomic layer deposition process; and
a top electrode, wherein the top electrode is comprised of a conductive material on the dielectric material.

18. The high-density capacitor system of claim 17, wherein the substrate includes a trough and the bottom electrode is at least partially located in the trough.

19. The high-density capacitor system of claim 17, wherein the substrate includes a trough and the bottom electrode, the dielectric material, and the top electrode are at least partially located in the trough.

20. The high-density capacitor system of claim 17, wherein the area enhancement factor for the high-density capacitor system is greater than around 40.

21. The high-density capacitor system of claim 17, wherein the area enhancement factor for the high-density capacitor system is greater than around 90.

22. The high-density capacitor system of claim 17, further comprising a conductive pad in communication with the top electrode.

23. The high-density capacitor system of claim 22, wherein the conductive pad is provided in communication with a trace on an integrated circuit layer.

24. The high-density capacitor system of claim 22, wherein the conductive pad is provided in communication with the integrated circuit layer by a through-silicon-via.

25. The high-density capacitor system of claim 22, wherein the high-density capacitor system provides a capacitance density of greater than 40 μF/cm².

26. The high-density capacitor system of claim 22, wherein the system has a thickness of less than 500 μm.
